(19) United States
(12) Patent Application Publication
(10) Pub. No.: US 2025/0131494 A1
(43) Pub. Date: Apr. 24, 2025

(54) AUTOMATED SYSTEM AND METHOD FOR COLLATEFRAL MANAGEMENT

(71) Applicant: Vermeg Factory, Tunis (TN)

(72) Inventors: Badreddine OUALI, Tunis (TN); Michael Carignano, Sceaux (FR); Majdi Nafti, Bussy-Saint-Georges (FR)

(73) Assignee: Vermeg Factory, Tunis (TN)

(21) Appl. No.: 18/924,787

(22) Filed: Oct. 23, 2024

Related U.S. Application Data
(60) Provisional application No. 63/545,264, filed on Oct. 23, 2023.

(51) Int. Cl. G06Q 40/02

(52) U.S. Cl. CPC G06Q 40/02

(57) ABSTRACT

This patent application presents EASY Collateral as a specialized solution designed for bank treasurers to seamlessly integrate with the Eurosystem Collateral Management System (ECMS), Central Banks, the European Central Bank (ECB), and Central Counterparties (CCP). This innovative tool offers bank treasurers permanent access to a comprehensive digital dashboard, providing real-time insights into their asset inventory within ECMS and CCP. With a user-friendly interface, users can effortlessly allocate and mobilize/demobilize credit claims and other marketable collateral with a single click. EASY Collateral also ensures compliance with the new Credit Claims Process, covering registration and mobilization, empowering bank treasurers to navigate evolving regulatory requirements confidently. Furthermore, the system mitigates operational risks while enhancing efficiency, enabling real-time decision-making. In the complex world of collateral management, EASY Collateral simplifies processes and empowers bank treasurers within the ECMS and CCP.

### RELATED APPLICATION

This application claim priority to U.S. Provisional Patent Application No. 63/545,264, filed on Oct. 23, 2023, the disclosure of which is incorporated by reference in its entirety.

### TECHNICAL FIELD

The present invention discloses a novel system and method for technologically advanced collateral management in transactions, particularly managing collateral for central banks and central counterparty transactions.

### BACKGROUND

Collateral management is a fundamental practice within the realm of financial services, enabling the efficient functioning of financial markets and the facilitation of various financial transactions. At its core, collateral management involves the prudent allocation, monitoring, and utilization of assets, typically in the form of securities, cash or credit claims, to mitigate risks associated with financial transactions. Collateral serves as a protective measure, ensuring that parties involved in a transaction can meet their financial obligations, particularly in cases of default.

Collateral, within this context, denotes financial assets or instruments tendered by participants in transactions to secure their obligations, temper risk, and ensure the smooth functioning of financial markets. The efficient management of collateral is indispensable for optimizing asset utilization while minimizing concomitant risks.

Within the specialized context of Central Banks, the European Central Bank (ECB), and Central Counterparties (CCP), collateral management takes on heightened significance and complexity. These institutions play pivotal roles in shaping monetary policies, safeguarding financial stability, and ensuring the integrity of financial markets. Consequently, the management of collateral within these entities becomes a critical component for the broader financial ecosystem.

Central Banks, the ECB, and CCPs deal with a wide array of asset classes, from government securities to complex financial derivatives. Managing this diverse range of assets efficiently and in compliance with regulatory requirements poses a significant challenge. Effective risk mitigation is a core objective in collateral management for these institutions. Ensuring that the collateral pledged adequately covers potential losses in the event of default requires sophisticated risk assessment and modeling capabilities. Streamlining the collateral management process to enhance operational efficiency is essential. These entities often handle large volumes of transactions and must ensure the seamless transfer and tracking of collateral assets. The regulatory landscape for Central Banks, the ECB, and CCPs is intricate and constantly evolving. Compliance with complex regulations and reporting requirements is imperative. In an era of increasing digitalization, ensuring the security of collateral assets and transactions is paramount. Cyber threats present ongoing risks that must be addressed robustly. The ability to seamlessly interact and exchange collateral with other financial institutions and counterparties is crucial for these entities. Achieving interoperability among different systems and participants can be challenging. Evolving Technology: Rapid advancements in technology, such as blockchain and artificial intelligence, offer opportunities for innovation but also require continuous adaptation to remain competitive and secure.

In the face of these multifaceted challenges, there is a pressing need for innovative solutions that not only address these issues but also advance the state of the art in collateral management for Central Banks, the ECB, and CCPs. This patent application introduces a novel system and method designed to tackle these challenges comprehensively, aiming to optimize collateral management processes and strengthen the financial infrastructure that underpins global markets.

In this ever-transforming landscape of Central Bank and CCP transactions, the imminent adoption of the Eurosystem Collateral Management System (ECMS) also presents a distinctive array of technical challenges. The ECMS represents a unified system for managing assets deployed as collateral within Eurosystem credit operations.

The implementation of the ECMS is anticipated to yield a myriad of advantages for various stakeholders. The ECMS promotes harmonization by facilitating the simultaneous implementation of the collateral framework and associated changes across all national central banks. This unification reduces disparities among systems, fostering a cohesive and standardized approach to collateral management.

The ECMS delivers an indispensable benefit to counterparties by eliminating the need to interact with diverse local collateral management systems. The ECMS contributes to the 2 broader financial market by offering a singular, comprehensive system for managing the pools of assets utilized as collateral in Eurosystem credit operations. This unified approach simplifies market operations, enhances transparency, and promotes a more robust and efficient financial ecosystem.

By consolidating the implementation of changes within a single system, the ECMS optimizes operational efficiency and reduces costs for all stakeholders. The elimination of redundancy and inefficiencies leads to resource optimization and financial benefits.

The ECMS actively supports the objective of financial integration and the realization of the capital markets union. By fostering an environment of connectivity and uniformity, the system contributes significantly to strengthening the financial ties that bind the Eurosystem.

The ECMS achieves these benefits by efficiently tracking individual collateral and credit positions of national central banks' counterparties. Leveraging data sourced from central securities depositories, triparty agents, and ECB/Eurosystem databases and/or applications, the ECMS calculates available credit lines for each counterparty. This information is seamlessly communicated to the central liquidity management tool. Counterparty mobilization instructions are transformed into settlement instructions, executed within TARGET2-Securities (T2S), thus ensuring operational efficiency.

Furthermore, the ECMS excels in handling corporate actions, triparty instructions, and credit claim mobilization in a standardized and harmonized manner, further contributing to the overall optimization of the collateral management process.

The ECMS is scheduled for full implementation and activation, commonly referred to as the “Go-Live Date,” on Apr. 8, 2024. On this significant date, the ECMS will transition from its development and testing phases to active operation.

Nonetheless, the transition to ECMS is not devoid of complexities. Technical intricacies emerge as existing legacy systems must harmoniously integrate with these innovative solutions. The secure transfer of digital assets and the real-time tracking of collateral necessitate robust cybersecurity measures. Moreover, ensuring interoperability between diverse ECMS 3 providers and aligning with evolving regulatory standards are of paramount importance. Crafting and implementing ECMS that effectively surmount these multifaceted technical challenges while satisfying the stringent requisites of Central Bank and CCP transactions is a significant milestone in the financial sector.

### SUMMARY

According to one aspect of the invention, a computer-implemented system for collateral management is disclosed, which includes a digital dashboard that provides real-time access to a user's inventory of collateral assets, such as cash, marketable assets, or credit claims. The system comprises a collateral allocation module that enables the allocation, mobilization, and demobilization of the collateral assets, alongside an eligibility module that verifies the eligibility of the assets based on predefined criteria. The system further includes a valuation module for determining the real-time market values of these assets and an asset allocation optimizer that recommends optimized allocations for financial transactions based on risk profiles and user-defined preferences. A messaging module allows communication with external collateral management and transaction systems, while a monitoring module tracks any changes related to the collateral assets.

In another aspect of the invention, the system can be integrated with external collateral management systems such as the Eurosystem Collateral Management System, Clearstream, or other central bank collateral management systems.

In a further aspect, the messaging module is capable of communicating with these external systems via secure channels, such as SWIFT messages or Central Counterparty Clearing House notifications.

According to another aspect, the system includes an alert system that notifies users in real-time of critical events, including margin calls, coupon payments, or changes in the status of assets.

In another embodiment, the collateral allocation module is configured to automatically adjust collateral allocations in response to changes in asset valuation or margin call requirements.

Additionally, the digital dashboard in one embodiment provides graphical representations of collateral positions, asset valuations, and transaction histories to improve the user experience.

In another aspect of the invention, the system further includes an audit module, which generates comprehensive logs for all transactions and changes related to collateral assets.

In yet another embodiment, the eligibility module is configured to dynamically update eligibility criteria based on changes in regulatory requirements or market conditions.

According to another aspect, the asset allocation optimizer is capable of simulating various allocation scenarios based on different risk profiles, market conditions, and user preferences.

The invention also provides a compliance module, ensuring that all collateral allocations adhere to predefined regulatory standards.

In one embodiment, the system can manage non-marketable collateral assets, such as credit claims or real estate, and includes functionality to mobilize and demobilize these non-marketable assets.

In another aspect, the valuation module integrates with external market data feeds to provide real-time updates on asset values, interest rates, and currency exchange rates.

Further, the messaging module is capable of receiving notifications from external systems related to transaction confirmations, rejections, or settlement updates.

According to another aspect of the invention, a method for managing collateral assets using a computer-implemented system is provided. This method involves offering real-time access to a digital dashboard displaying a user's collateral inventory, verifying the eligibility of collateral assets based on predefined criteria, determining real-time values for these assets, and optimizing their allocation for financial transactions using an asset allocation optimizer. The method also includes communicating with external collateral management and transaction systems and monitoring changes in collateral assets.

In a further embodiment, the method supports integration with the Eurosystem Collateral Management System or Clearstream for seamless management of collateral transactions.

Additionally, the method includes receiving and processing margin call alerts and updating collateral allocations in response.

The method can also include automatically rebalancing collateral allocations in response to market fluctuations or changes in asset eligibility.

Another aspect of the invention involves simulating various collateral allocation strategies and providing recommendations based on projected risk and liquidity needs.

Lastly, the method provides for generating audit logs for all collateral-related transactions, including allocations, mobilizations, and demobilizations, and ensuring that collateral assets are validated against internal eligibility criteria and external regulatory requirements before they are mobilized in financial transactions.

### BRIEF DESCRIPTION OF DRAWINGS

The foregoing summary, as well as the following detailed description of the preferred embodiments, will be better understood when read in conjunction with the appended drawings. It should be understood, however, that the invention is not limited to the precise arrangements and instrumentalities shown. In the drawings,

FIG. 1 provides an exemplary overview of the EASY Collateral solution for national central banks;

FIG. 2 provides an exemplary overview of the EASY Collateral solution for ECB;

FIG. 3 provides an exemplary overview of the EASY Collateral solution for CCP;

FIG. 4 provides an exemplary illustration of the Easy Collateral system for use with ECB;

FIG. 5 shows an exemplary integration of Easy collateral with various services;

FIG. 6 provide an exemplary flowchart illustrating ingesting collateral relevant information from CCP and bank participants;

FIG. 7 describes an exemplary workflow of a Collateral Deposit system;

FIG. 8 illustrates an exemplary Marketable asset workflow for Central Bank;

FIG. 9 illustrates an exemplary Marketable Asset Instruction;

FIG. 10 illustrates an exemplary marketable asset workflow for CCP;

FIG. 11 is an exemplary overview of cloud implementation of Easy Collateral

FIG. 12 is an example of Easy Collateral CCP Dashboard. The dashboard provides Account Overview, Inventory, and Alerts;

FIG. 13 is example of Easy Collateral ECB Dashboard. The dashboard provides Pool Overview, Needs to be covered, Inventory details, and Alerts;

FIG. 14 is example of Easy Collateral Central Bank Dashboard. The dashboard provides Margin Pool, Auction results, Inventory details, and alerts;

FIG. 15 is example of Easy Collateral screen for CCP collateral deposit;

FIG. 16 is example of Easy Collateral screen for ECB mobilization;

FIG. 17 is example of Easy Collateral screen for central bank allocation;

FIG. 18 is example of Easy Collateral screen for CCP collateral withdrawal;

FIG. 19 is example of Easy Collateral screen for ECB demobilization;

FIG. 20 is example of Easy Collateral screen for central bank demobilization;

FIG. 21 is example of Easy Collateral screen for CCP collateral substitution; and

FIG. 22 is example of Easy Collateral screen for central bank collateral substitution.

### DETAILED DESCRIPTION

EASY Collateral stands as a pioneering solution crafted for bank treasurers, offering seamless integration with the European Collateral Management System (ECMS), and to Central Counterparties (CCP) clearing house. This innovative digital platform empowers banks to streamline and enhance their collateral management processes, including leveraging Clearstream Triparty Services.

EASY Collateral provides a comprehensive digital dashboard. The digital dashboard provides an intuitive interface giving a holistic view of collateral management activities, ensuring all the tools one needs at their disposal.

EASY Collateral also provides a real-time asset inventory. EASY Collateral gives real-time visibility into the inventory of available assets. EASY Collateral offers an up-to-the-minute snapshot of collateral, including amount of available assets held in Clearstream.

EASY Collateral further provides effortless allocation and mobilization/demobilization of collateral assets. EASY Collateral manages credit claims, marketable assets, and cash. With EASY Collateral, one can allocate and demobilize these assets with just a single click. The system and method offer direct connectivity to ECMS or the option to go through Clearstream Triparty Services.

Additionally, EASY Collateral reduces operational risk. EASY Collateral prioritizes risk mitigation. By streamlining and automating collateral management, it significantly reduces operational risks, ensuring that your transactions are executed smoothly and securely.

At the same time, EASY Collateral enhances Operational Efficiency. By simplifying complex collateral processes, it allows users to achieve more with fewer resources. This efficiency translates into cost savings and improved performance.

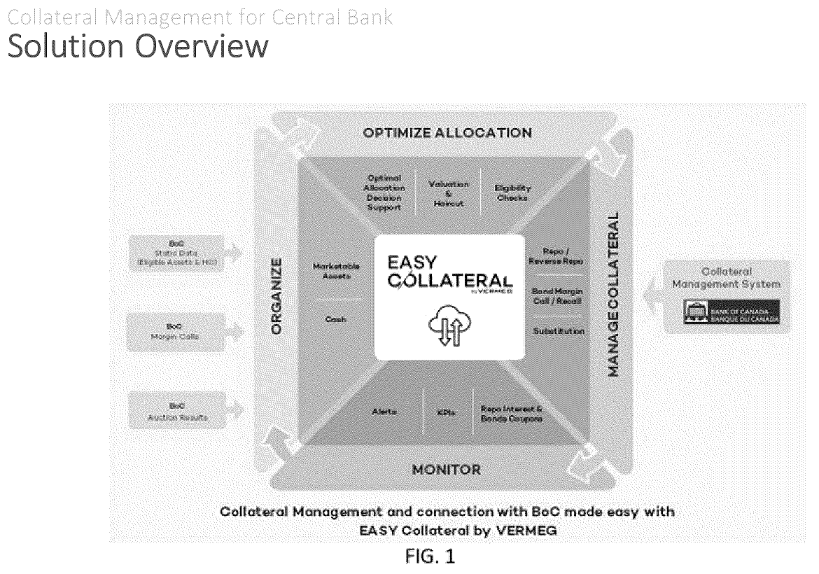

FIG. 1 provides an overview of the EASY Collateral solution for national central banks. The Solution generally provides four functionalities:

### 1. Collateral Asset Organization

Central Banks often handle a vast and diverse range of collateral assets, from government bonds to various financial instruments. The Easy Collateral Solution simplifies this complexity by providing an intuitive interface that allows Central Banks to categorize, classify, and digitize collateral assets. This system employs advanced data management techniques to create a centralized collateral asset database, ensuring easy access to information regarding asset types, quality, and availability.

Easy Collateral generally categorize and classify the inputs into two categories: marketable assets and cash. It evaluates factors like asset type, maturity, liquidity, and haircut to make informed decisions about the allocation of assets and the need for cash reserves. This dynamic classification ensures that Central Banks can optimize their collateral portfolio to meet liquidity and risk management objectives.

Easy Collateral offers a comprehensive platform to efficiently organize and classify the following data inputs:

a. Eligible Assets and Haircuts (HC)

The system allows for the seamless input of data related to eligible assets. Central Banks can input comprehensive information about the types of securities, their quantities, maturities, and credit ratings. Importantly, the system also accommodates data on haircuts, which represent the percentage reduction in the market value of collateral to account for potential price fluctuations. These inputs lay the foundation for determining the value and classification of collateral assets.

b. Margin Calls

Central Banks often receive margin calls as part of collateral management. Users can conveniently input margin call details, including the date of the call, the amount requested, and the corresponding collateral assets. The system uses this information to evaluate and adjust the allocation of assets, considering the liquidity needs arising from margin calls. ECMS notify Counterparties when the Pool is in deficit. Easy Collateral will raise an alert to inform users they need to cover the deficit.

c. Auction Results

Easy Collateral displays the Auction results received from a Central Bank, which helps Dealers cover the Cash leg with a selection of assets, using manual or optimal allocation.

### 2. Optimization of Collateral Allocation

Efficient allocation of collateral is a central concern for Central Banks. The Easy Collateral Solution leverages data analytics and optimization algorithms to assist Bank treasurers in making informed decisions regarding collateral allocation. It provides real-time insights into collateral usage, offering recommendations for optimizing the allocation of assets based on risk assessments, market conditions, and regulatory requirements. This dynamic allocation approach enhances ECMS Participants' ability to manage liquidity and risk effectively.

Easy Collateral also includes a robust suite of features to optimize the allocation of collateral assets. This optimization process involves decision support, valuation and haircut calculations, and eligibility checks to ensure that Central Banks maximize the use of their collateral while adhering to regulatory and risk management requirements.

a. Optimal Allocation Decision Support

Central Banks often face complex decisions regarding how to allocate collateral across various financial transactions. The system provides decision support tools that leverage data analytics and historical performance to recommend optimal allocation strategies. These recommendations take into account factors such as market conditions, risk profiles, and liquidity needs. Users can evaluate different allocation scenarios and select the one that aligns best with their objectives.

b. Valuation and Haircut Calculation

Accurate valuation of collateral assets is paramount for effective allocation. The “Easy Collateral Solution” integrates real-time market data and valuation models to determine the current value of each asset in its inventory. Additionally, it calculates appropriate haircuts based on same parameters applied by ECMS. These valuation and haircut calculations ensure that the allocation of collateral assets reflects their true market worth, while accounting for potential fluctuations in value.

c. Eligibility Checks

Compliance with regulatory and internal eligibility criteria is critical in collateral allocation. The system conducts automated eligibility checks against predefined criteria, ensuring that only qualified assets are considered for allocation. These checks encompass credit ratings, asset type, issuer information, and any other criteria specified by the Central Bank or regulatory authorities. By automating this process, the “Easy Collateral Solution” minimizes the risk of using ineligible assets.

### 3. Collateral Management

Managing collateral assets can be a labor-intensive and error-prone process. This solution simplifies collateral management through automation and smart contract integration. It automates the collateral pledging process, ensuring timely delivery and settlement. Additionally, it enables the tracking of collateral movements, revaluation, and substitution, while offering a secure and auditable transaction history. By reducing manual intervention, this system minimizes operational risks and enhances efficiency.

Easy Collateral provides a comprehensive framework for managing collateral assets efficiently and transparently, encompassing a range of operations and interfaces tailored to the needs of Central Banks.

a. Repo and Reverse Repo Operations:

The system facilitates repo (repurchase agreement) and reverse repo transactions, enabling Central Banks to efficiently borrow and lend collateral assets. Users can initiate, track, and manage these transactions within the platform. The system automates the collateral pledge process, manages collateral movement between parties, and ensures compliance with agreed-upon terms and conditions. It also maintains a comprehensive record of repo and reverse repo transactions for auditing and reporting purposes.

b. Bond Margin Call and Recall:

Margin calls are a vital aspect of collateral management, particularly when managing bonds and securities. Easy Collateral simplifies margin call and recall processes. When margin calls are triggered due to changes in asset values, the system automatically generates notifications and instructions for collateral adjustments. Users can easily process margin calls, including recalling collateral, when necessary, to maintain compliance with margin requirements.

c. Collateral Substitution:

Collateral substitution is a common practice to optimize collateral portfolios. Users can initiate collateral substitution requests within the system. The platform automates the evaluation of substitution eligibility, ensuring that replacement collateral meets predefined criteria. Additionally, the system tracks the flow of collateral assets during the substitution process and maintains a clear audit trail of all substitutions for transparency and compliance.

Easy Collateral is designed for seamless integration with Central Banks' existing collateral management systems. This interfacing capability ensures that Banks (e.g., ECMS or CCP participants) can leverage the advantages of Easy Collateral while maintaining consistency with their established systems, minimizing disruption and enhancing operational efficiency.

### 4. Real-time Collateral Monitoring

The Easy Collateral Solution provides Participants or Banks with real-time monitoring capabilities to track the transactions workflow. It gives treasurers with a real-time status on the instructions they initiated in EC, whether it has been confirmed or rejected by ECMS or CCP. This real-time visibility allows Central Banks to proactively manage collateral and respond to changing market conditions effectively.

Easy Collateral provides automated alerts, KPI tracking, and the monitoring of repo interest and bonds coupons.

a. Real-time Alerts:

Easy Collateral offers a robust alerting system that notifies users of critical events and changes in real-time. Alerts are triggered for various scenarios, including:

Margin Call Triggers: Immediate alerts are sent when margin call thresholds are reached, allowing for swift response to collateral requirements.

Coupon and Interest Payments: Notifications are generated when interest and coupon payments are received, ensuring timely tracking of income generated from collateral assets.

Repo and Reverse Repo Activity: Alerts are provided for the initiation and completion of repo and reverse repo operations, allowing for immediate monitoring of these transactions.

b. Key Performance Indicators (KPIs):

The system incorporates a dashboard that displays KPIs related to collateral management. Users can customize these KPIs to track specific performance metrics that align with their operational objectives. Common KPIs include:

Collateral Utilization Rate: Monitoring how effectively collateral assets are being used in transactions.

Risk Exposure: Assessing the level of risk associated with the collateral portfolio.

Liquidity Position: Tracking the availability of cash or easily marketable assets to meet immediate needs.

c. Repo Interest and Bonds Coupons Monitoring:

Easy Collateral includes functionality for tracking repo interest and bonds coupons. Users can input and monitor these income streams associated with their collateral assets. The system provides a clear overview of when interest and coupon payments are due, ensuring that these income sources are managed efficiently.

In addition to its impressive capabilities in collateral management for Bank Treasurers, EASY Collateral stands out as a highly adaptable and modular platform. This unique feature enables it to seamlessly support critical operations of the European Central Bank (ECB) and other central banks, making it an indispensable tool for the most demanding financial institutions. EASY Collateral's modular architecture allows it to be customized to the specific needs and requirements of ECB.

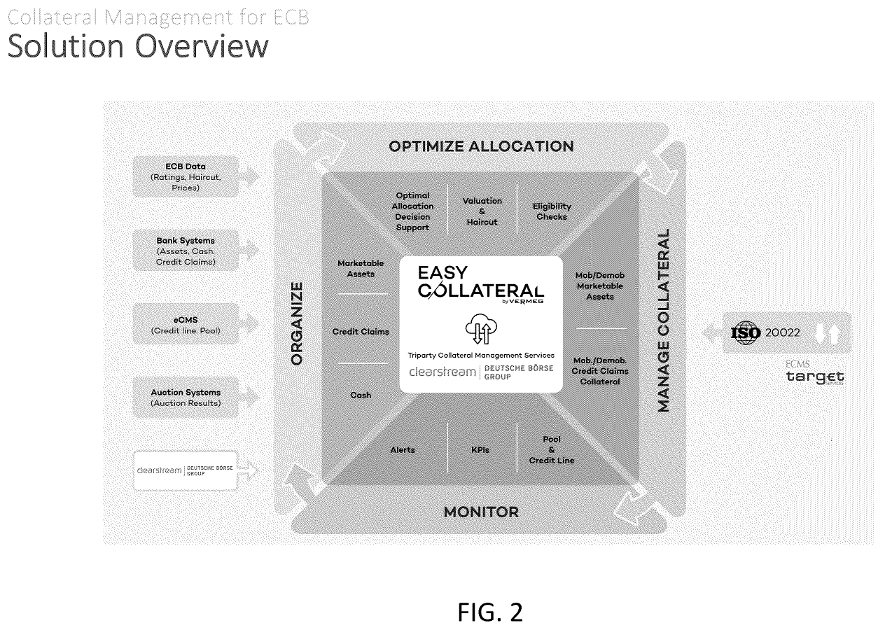

EASY Collateral is designed to facilitate direct integration with the ECB's infrastructure. This means that central banks can seamlessly connect to the ECB's systems, streamlining their collateral management processes and ensuring compliance with ECB policies and standards. FIG. 2 provides an overview of the EASY Collateral solution for ECB.

### 1. Collateral Asset Organization

In the ECB mode, Easy Collateral is designed to seamlessly integrate data from various sources to provide a comprehensive and real-time view of collateral assets and transactions. Here's how each data input source contributes to the system:

a. ECB Data (Ratings, Haircut, and Prices)

Ratings: The system incorporates credit ratings of collateral assets provided by the ECB or relevant credit rating agencies. These ratings are used to assess the creditworthiness of assets and determine their eligibility and suitability for collateral purposes.

Haircut: ECB-defined haircut values for different asset classes are integrated to calculate the adjusted value of collateral assets. These haircuts account for market risk and fluctuations in asset values.

Prices: Real-time or periodic market prices for collateral assets are fetched and used for valuation. This data ensures that the collateral portfolio's value accurately reflects market conditions.

b. Bank Systems (Assets, Cash, Credit Claims)

Assets: Data from bank systems regarding eligible collateral assets, including government securities, corporate bonds, and other financial instruments, is ingested. This includes information on asset types, quantities, and maturities.

Cash: Information on available cash reserves held by Central Banks or financial institutions is integrated. Cash availability plays a crucial role in collateral allocation and liquidity management.

Credit Claims: Data related to credit claims and receivables is included. This may involve information on loans, credit quality, and recovery values.

c. eCMS (Credit Line, Pool)

Credit Line: Information on credit lines and limits established within the Electronic Collateral Management System (CMS) is imported. This data assists in managing credit exposure and determining the collateral available for borrowing.

Pool: Details about collateral pools, including their composition and performance metrics, are integrated. Pool data helps in optimizing collateral allocation strategies.

d. Auction Systems (Auction Results)

Open Market Operation can be integrated from Participants System to be displayed in Easy Collateral Dashboard.

e. Clearstream:

Clearstream Data: Information from Clearstream, which often serves as a central securities depository and custodian, is integrated. This includes data on securities holdings, settlements, and corporate actions that impact collateral assets.

Additionally, in the Central Bank mode, Easy Collateral generally categorize and classify the inputs into three categories: marketable assets, credit claims, and cash. It evaluates factors like asset type, maturity, liquidity, and haircut to make informed decisions about the allocation of assets and the need for cash reserves. This dynamic classification ensures that ECB can optimize their collateral portfolio to meet liquidity and risk management objectives.

### 2. Optimization of Collateral Allocation

In ECB mode, optimization of collateral allocation is essentially similar in the Central Bank mode.

### 3. Collateral Management

Easy Collateral provide robust tools for managing collaterals.

a. Mobilization and Demobilization of Marketable Assets

Asset Selection: Users can select specific marketable assets from their collateral portfolio for mobilization. The system provides detailed information about each asset, including type, quantity, market value, and eligibility status.

Eligibility Checks: Before mobilization, the system conducts real-time eligibility checks to ensure that the selected assets meet the criteria for the intended transaction, such as mobilization and demobilization of marketable asset & credit claims.

Transaction Initiation: Users can initiate mobilization transactions directly within the system. Asset is selected and quantity can be modified.

Automated Workflow: Once initiated, the system streamlines the workflow, automating the collateral pledge process. It ensures the seamless transfer of marketable assets to the counterparty, while maintaining accurate records of the transaction.

Real-time Updates: Throughout the mobilization process, the system provides real-time updates on the status of the transaction, including confirmation of asset transfer and compliance with terms and conditions.

Recording and Audit: A comprehensive record of mobilization/demobilization transactions is maintained for audit purposes, including transaction details, asset transfer confirmations, any associated notifications, and the user that has initiated the transaction, with the date & time stamp.

b. Mobilization and Demobilization of Credit Claims Collateral

Credit Claim Selection: Users can select credit claims collateral for mobilization or demobilization based on the specific requirements of credit agreements or credit lines.

Transaction Initiation: The system allows users to initiate registration, mobilization, demobilization, and update transactions related to credit claims collateral. This includes specifying the details of the transaction, such as the amount of credit claims, terms, and involved parties.

Automated Workflow: Similar to marketable assets, the system automates the workflow for credit claims collateral, ensuring efficient transfer and management.

Real-time Updates: Users receive real-time updates on the progress of credit claims collateral transactions, including confirmation of successful mobilization or demobilization.

Easy Collateral integration with ECMS Target Services through the ISO 20022 messaging protocol is a significant enhancement that allows for seamless communication and data exchange between the two systems. It promotes efficient, secure, and standardized communication, enhancing the effectiveness of collateral management processes and contributing to the stability and reliability of Central Bank and financial institution operations.

### 4. Real-time Collateral Monitoring

Easy Collateral is equipped to provide a comprehensive set of features, including alerts, key performance indicators (KPIs), and status tracking for pools and credit lines. These capabilities ensure effective oversight and decision-making in collateral management processes.

a. Alerts:

The alert system within Easy Collateral is designed to notify users of critical events and changes in real-time. Alerts cover a range of scenarios, including but not limited to:

Margin Call Triggers: Immediate alerts are generated when ECMS notifies the Bank that its Pool is in deficit.

Asset reaching maturity: an alert is generated when a mobilized asset is nearly maturing.

Return asset: an alert is raised when a mobilized asset does not longer belong (totally or partially) to the participant's inventory.

Not-Eligible asset: when a mobilized asset becomes ineligible, EC generates an alert to help user demobilize the 0-valued assets.

b. Key Performance Indicators (KPIs):

The monitoring function provides a dashboard displaying KPIs relevant to collateral management. Users can customize these KPIs to align with their specific operational objectives.

c. Pool and Credit Line Status Tracking:

The system offers comprehensive status tracking for collateral pools and credit lines:

Collateral Pool Status: Users can view the current status of collateral pools, including their utilization, composition, and eligibility. Changes in pool status trigger alerts and notifications.

Credit Line Status: The status of credit lines, including utilization, available credit, and any credit limit adjustments, is readily accessible. Users are alerted when credit line status changes.

Pool Performance Analysis: Beyond status, the system provides tools for analyzing the performance of collateral pools, enabling users to make informed decisions about pool management and allocation.

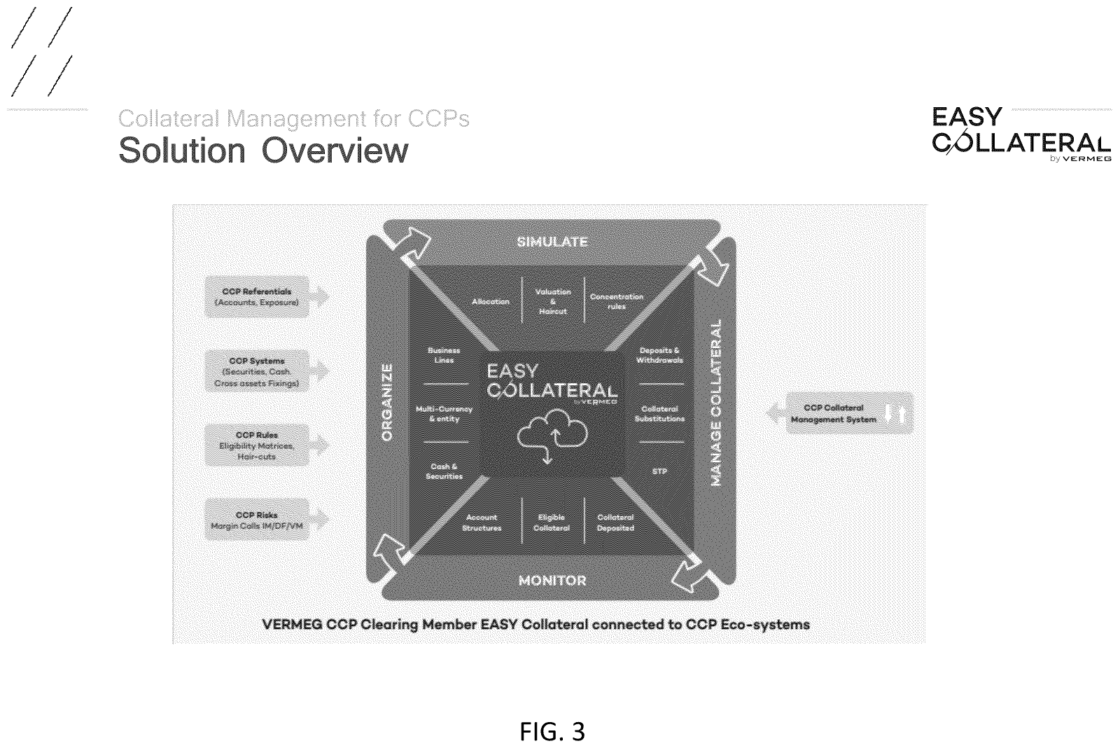

The modular design of the Essay Collateral system can also be applied to operate with CCPs (Central Counterparties). In the CCP mode (FIG. 3), Easy Collateral can take integrate various data input from the CCP, which may include:

### 1. CCP Reference Data (Accounts, Exposure)

CCP Accounts: CCP will input all data related to Clearing Members referential, including collateral accounts structure and account types. This ensures that “Easy Collateral” has a comprehensive understanding of the user's CCP accounts.

Collateral account details: Information about the margin requirements and the collateral deposited to cover the exposure are communicate by the CCP to Easy Collateral. User will have a global overview on accounts held at the Clearing House, including the securities details.

### 2. CCP Systems (Marketable Assets and Cash)

Marketable assets: CCP will communicate the assets that can be used as collateral. A list is updated on a daily basis and shared within EC system.

Cash Data: CCP provides the list of Eligible cash asset or currencies that are eligible as collateral by business line.

### 3. CCP Rules (Eligibility Matrices, Haircuts)

Eligibility Matrices: Users can input eligibility matrices that define which assets or securities are eligible for collateral purposes within CCP systems. These matrices are used by “Easy Collateral” to determine the eligibility of collateral assets.

Haircut Data: The system can incorporate haircut values specified by the CCP for different asset classes and securities. Haircuts are essential for calculating the adjusted value of collateral assets and assessing their risk.

### 4. CCP Risks (Margin Calls-IM/DF/VM)

Initial Margin (IM) Calls: Data related to IM calls, including the calculation methodology and frequency, can be entered into the system. “Easy Collateral” uses this data to assess IM requirements and generate alerts for margin call triggers.

Default Fund (DF) Contributions: Information about DF contributions, including contribution amounts and payment schedules, can be managed within the system. This ensures that users are aware of their obligations to the DF.

Variation Margin (VM) Calls: Data related to VM calls, including calculation methods and timing, can be incorporated. “Easy Collateral” monitors VM calls in real-time and provides alerts for VM margin call triggers.

Easy Collateral can simulate collateral allocation, valuation, haircut calculations, and concentration rules. Simulation allows users to proactively identify and address potential risks before they impact the actual collateral portfolio. Users can fine-tune collateral allocation strategies based on simulated scenarios, ensuring that collateral is allocated efficiently to meet liquidity and risk management goals. Simulation also helps users maintain compliance with concentration rules and regulatory requirements, reducing the risk of non-compliance. Users can engage in scenario planning to prepare for different market conditions and better understand the potential outcomes of various collateral management decisions. Simulation provides users with data-driven insights into the impact of their collateral management choices, enabling more informed decision-making.

Users can simulate different collateral allocation scenarios to evaluate the impact on their collateral portfolio. This includes testing various allocation strategies and assessing how different asset combinations affect the portfolio's risk and liquidity profile.

Users can also simulate market scenarios to assess the impact on collateral valuation. This includes modeling changes in market prices, interest rates, and credit spreads to understand how these factors affect the value of collateral assets.

Simulating haircut calculations helps users understand how changes in market conditions and asset quality affect haircut values. It allows for stress testing to evaluate the resilience of collateral assets under adverse conditions.

Users can further simulate the effects of concentration rules on their collateral portfolio. This involves testing scenarios where concentration limits are exceeded to assess the associated risks and consequences.

By simulating concentration rules, users can ensure compliance with regulatory and internal policies. The system can provide alerts or notifications when concentration limits are approached or breached in the simulation.

Easy Collateral can also integrate CCP (Central Counterparty) collateral management system and perform functions such as deposits and withdrawals, collateral substitutions, and STP (Straight-Through Processing). Easy Collateral seamlessly exchanges data with the CCP collateral management system, ensuring accurate and up-to-date information about collateral assets, eligibility criteria, and requirements. The system automates various collateral-related transactions, making it efficient to deposit, withdraw, or substitute collateral assets as needed to meet CCP requirements.

### 1. Deposits and Withdrawals

Deposits: Users can initiate deposit transactions within “Easy Collateral” to provide additional collateral assets to the CCP. The system verifies asset eligibility, checks compliance with CCP rules, and ensures proper documentation.

Withdrawals: Users can request withdrawals of excess collateral assets from the CCP. “Easy Collateral” validates eligibility and compliance with CCP criteria before initiating the withdrawal process.

### 2. Collateral Substitutions

Collateral Substitutions: Users can request collateral substitutions when assets need to be replaced with others that better meet CCP eligibility or risk criteria. “Easy Collateral” evaluates the eligibility of substitute collateral and automates the substitution process.

### 3. Straight-Through Processing (STP)

Automation of Transactions: Easy Collateral facilitates STP by automating the processing of collateral transactions. This reduces manual intervention, minimizes errors, and accelerates transaction settlement.

Easy Collateral offers comprehensive monitoring capabilities that include overseeing account structures, eligible collateral, and collateral deposits.

### 1. Account Structure Monitoring

Hierarchical View: Easy Collateral provides users with a hierarchical view of the account structure within the CCP. This view may include primary accounts, sub-accounts, and associated entities.

Account Ownership: Users can identify and monitor the ownership of accounts within the CCP structure, differentiating between proprietary accounts, client accounts, omnibus accounts, and other types as applicable.

### 2. Eligible Collateral Monitoring

Eligible Collaterals: List of eligible securities is provided by the CCP. EC will use that list to calculate the eligible asset available in the inventory of the Clearing Member (CM).

Real-time Eligibility Checks: The system conducts real-time eligibility checks on collateral assets to ensure they meet the CCP's predefined eligibility criteria. This feature prevents the use of ineligible assets for collateral purposes.

Alerts for Ineligible Collateral: Users receive alerts and notifications when the system identifies collateral assets that do not meet the established eligibility criteria, enabling prompt action to address non-compliance with CCP requirements.

### 3. Collateral Deposits Monitoring

Easy Collateral tracks collateral deposits made to the CCP. Users can monitor critical details, including the quantity, type, valuation, and location of deposited collateral assets.

Margin Call Compliance: The system ensures that collateral deposits align with margin call requirements, helping users maintain compliance with CCP margin rules.

Real-time Deposit Updates: Users receive real-time updates on the status of collateral deposits, including confirmation of successful deposits and changes in collateral availability.

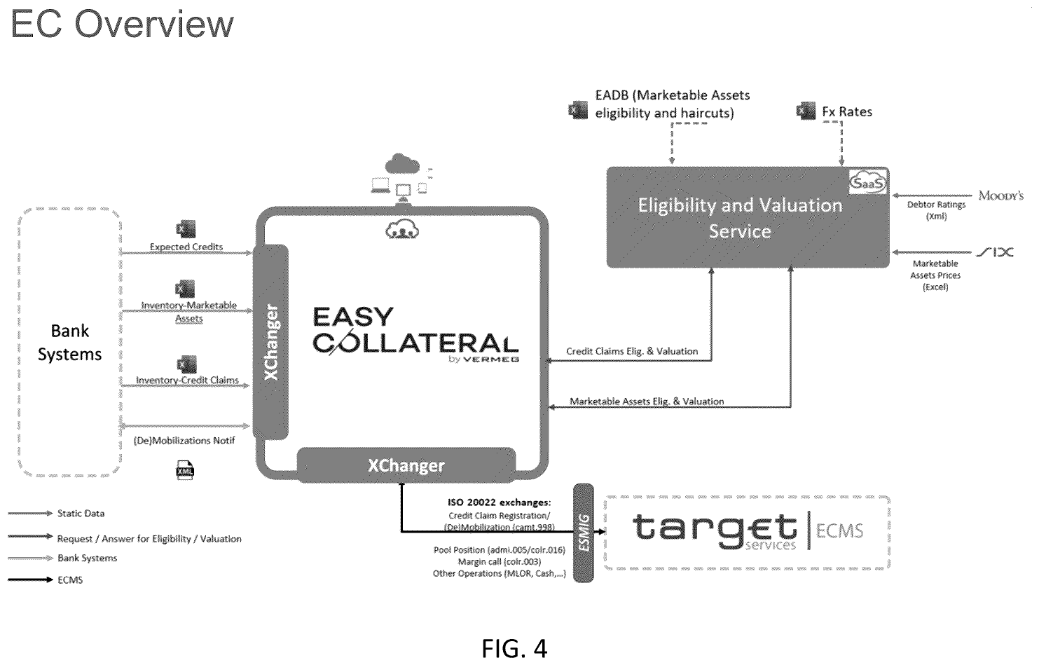

FIG. 4 provides a more detailed illustration of a particular implementation of the Easy Collateral system for use with ECB. Bank systems provide formatted data, such as Expected credits, inventory of marketable assets, inventory of credit claims, mobilization/demobilization notifications to the Easy Collateral system. Easy Collateral also receives credit claims eligibility and valuation, and marketable assets eligibility and valuation from eligibility and valuation service, which can be implemented as software as a service. The eligibility and valuation service integrates EADB (Marketable Assets eligibility and haircuts) and Foreign exchange (Fx) rates, and third party services such as Moody's Debtor ratings, and SIX marketable assets prices. Easy Collateral seamless communicate with ECMS via Eurosystem Single Market Infrastructure Gateway (ESMIG), which includes credit claim registration, pol position, and other operation.

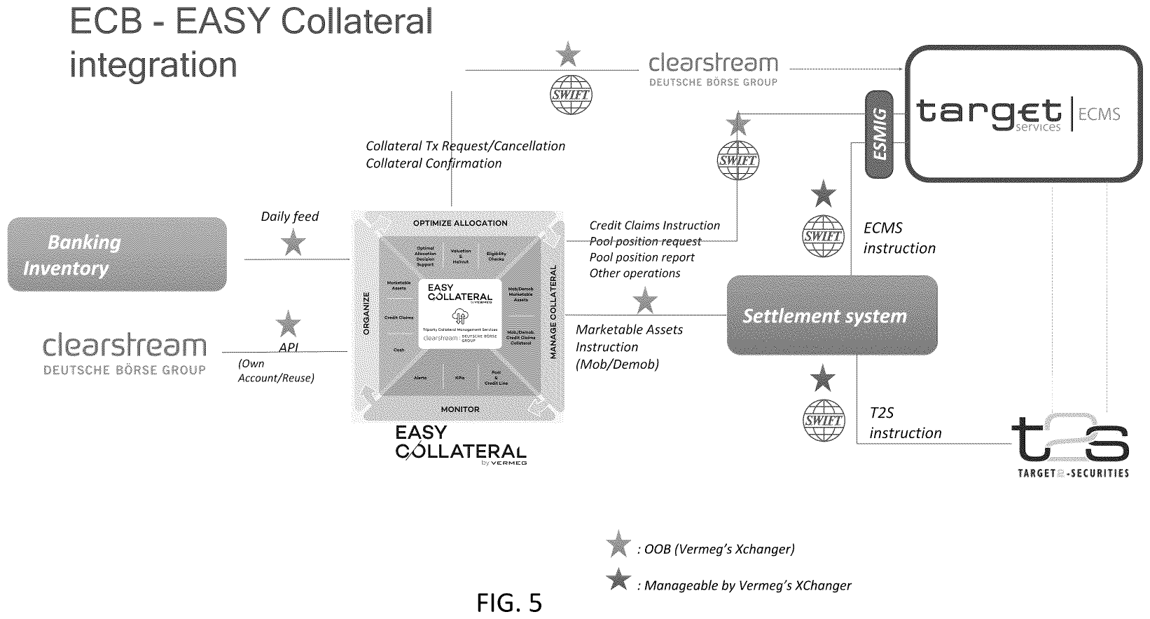

FIG. 5 shows integration of Easy collateral with various services. Easy Collateral integrates with banking inventory via daily feed, Clearstream via provided API. Easy collateral can transact with ECMS Target Services either directly vis ISO 20022 SWIFT messaging, or via a client's existing Clearstream service. Easy Collateral can also utilize the ECMS settlement system and transact with Target Services or Target2-securities services. Transactions include collateral transfer request, cancellation, or confirmation; credit claims instruction, pool position request, pool position report, and other operations.

The TARGET2 Services of the European Collateral Management System (ECMS) play a pivotal role in the efficient functioning of the Eurosystem's financial ecosystem. These services are designed to facilitate secure and timely settlement of financial transactions, particularly in the context of collateral management and the optimization of collateral usage.

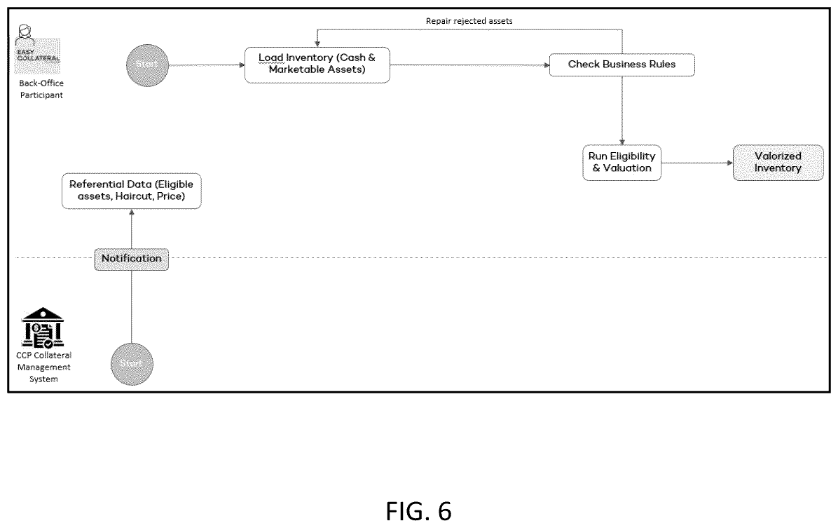

FIG. 6 provide a flowchart illustrate two examples of ingesting collateral relevant information. In one example, Easy Collateral will be integrated to the Banks Inventory system to gather the Inventory list and load it into Easy Collateral. As a contingency process, Easy Collateral offers the possibility to upload manually the inventory feed file based on Excel templates. The data file is typically structured such as an Excel data file. The collateral positions can be any of cash and marketable assets.

The system immediately triggers a sequence of operations, commencing with an initial data validation process. Subsequent to upload of the inventories, the inventory data is checked against relevant business rules for conformity to the prescribed format, completeness, and consistency. The ruleset including but not limited to asset type thresholds, credit ratings, and a comprehensive of requisites with respect to any categories of collaterals.

Easy Collateral conducts eligibility assessments to determine whether each asset qualifies for use as collateral. Asset types, credit ratings, and other criteria defined by users or regulators are scrutinized. Simultaneously, the system calculates the current market values of eligible assets. Whether it involves fetching real-time market data or using internal pricing models, the aim is to provide an accurate valuation of each asset.

As eligible assets are identified and valuated, they come together to form what we call the “valorized inventory.” This inventory is a snapshot of the current market values of all eligible assets, and it reflects their adherence to business rules and eligibility criteria.

In the event that an uploaded asset fails one or more of the business rules, the Easy Collateral system would reject the asset and alert the end user. The system identifies these rejected assets and provides users with a thorough list of reasons for their rejection. Users are then prompted to repair the rejected assets. This might entail updating asset information, providing additional documentation, or taking other necessary corrective actions. The goal is to bring these assets up to the standards set by the business rules.

Once repaired, Easy Collateral revalidates the updated data against the business rules, eligibility criteria, and valuation calculations. Only when the assets meet all the requirements are they officially incorporated into the valorized inventory, ready to serve their role as collateral.

Other approach to ingesting collateral assets into the Easy Collateral from CCP Collateral Management System. When operating with CCP Collateral Management System, collaterals assets are ingested into Easy Collateral via notification. The notifications may include referential data (eligible assets, haircut, and price).

EASY Collateral incorporates the eligibility checks and haircuts employed by ECMS and CCPs for marketable and non-marketable assets. By leveraging these parameters, EASY Collateral ensures pre-validation and accurate valuation of inventory, minimizing the risk of deviation from ECMS and CCP Collateral acceptance rules. This feature streamlines the collateral assessment process, enabling Bank treasurers to initiate transactions, based on reliable and up-to-date information.

By adopting standardized parameters and processes for Valuation and Eligibility, the Simulation functionality helps final users to anticipate ECMS and CCP calculations in order to reduce the risk of transactions rejections, improving consistently the operational efficiency.

EASY Collateral provides a seamless interaction with ECMS, particularly in terms of ISO 20022 messaging rules. This new generation of MX swift messages in not yet handled by all financial institutions. This feature offers turn-key connectivity, enabling customers to generate and interpret ISO 20022 messages effortlessly. By a single click in the Application transaction screens, Easy Collateral is built to generate hundreds of swifts to be send o ECMS in the proper format, saving time to Back-Office department to create the messages separately.

This functionality enhances communication and coordination between the application and ECMS, facilitating efficient data exchange and improving the overall collateral management workflow.

Easy Collateral handles all Collateral-related ISO 20022 swift messages, as defined and accepted by ECMS. This innovative feature promotes interoperability and data accuracy, contributing to streamlined collateral management processes.

EASY Collateral incorporates a sophisticated rule-based asset selection mechanism, allowing users to optimize their collateral allocation. By leveraging predefined rules and algorithms, the app assists Bank treasurers in identifying the most suitable assets for collateralization, ensuring efficient use of available resources and minimizing risk.

Through its rule-based asset selection optimization and integration with CCP activity, EASY Collateral provides financial institution with enhanced collateral optimization opportunities. The app assists front-office treasurers in identifying the most suitable assets for collateralization, maximizing the utilization of available resources and optimizing the allocation process. This optimization contributes to improved liquidity management and cost efficiency.

Finally, EASY Collateral automates the registration of credit claims and emphasize the management of the new credit claims mobilization process. By automating these tasks, the app reduces manual effort, enhances accuracy, and improves the overall efficiency of credit claims management for Eurozone bank treasurers.

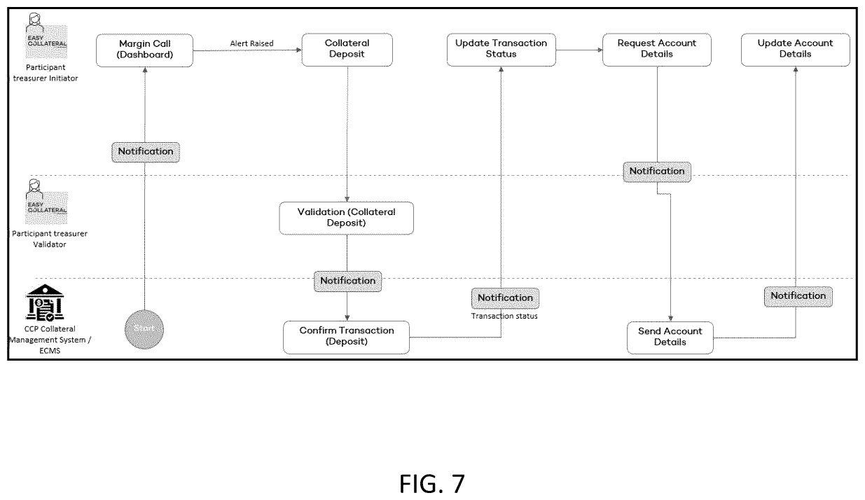

FIG. 7 describes the workflow of a Collateral Deposit. The process commences with the issuance of a margin call by the CCP. This crucial communication is transmitted via notification and promptly appears on the dashboard of the participant treasurer initiator within the Easy Collateral system. The margin call alerts the participant to an impending collateral requirement.

Upon the margin call's arrival, an alert is swiftly triggered within the Easy Collateral system. This alert indicates an imminent need for a collateral deposit. It draws the participant treasurer initiator's attention to the urgency of the situation.

The participant treasurer initiator selects appropriate collateral. The selected collateral is validated by the participant treasurer validator.

Once the collateral is deemed suitable, it is earmarked for deposit with the CCP. This intent to deposit is transmitted to the CCP via a notification, signaling the participant's commitment to fulfill the margin call.

In response to the participant's notification, the CCP acknowledges receipt of the collateral deposit. This acknowledgment is transmitted promptly also via notification.

The CCP updates the participant treasurer initiator regarding the transaction's status. This ensures transparency and keeps the participant abreast of the deposit's progress.

Easy Collateral system, updates the transaction status for the participant treasurer initiator, providing a comprehensive overview of the deposit's evolution.

The participant treasurer initiator may request account details from the CCP after deposition of collateral in response to the margin call. Upon the participant's request, the CCP promptly transmits the requisite account details to the participant treasurer initiator via a notification. Easy Collateral receives the information from the CCP and promptly updates the participant treasurer initiator's records with the newly acquired account details.

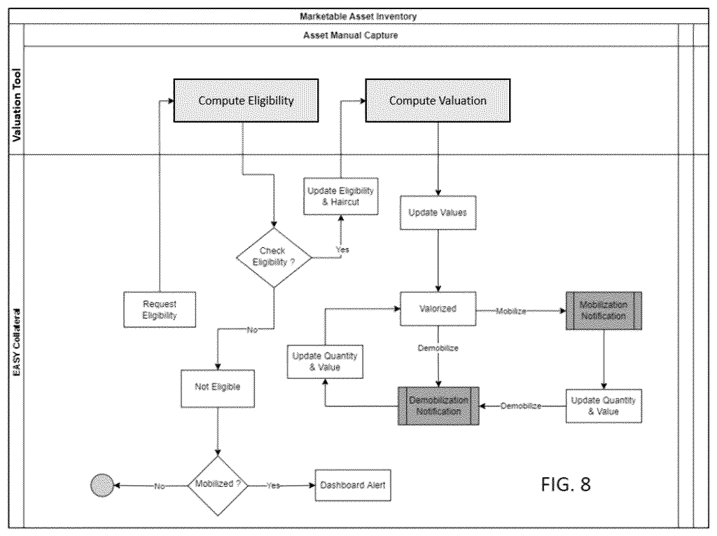

FIG. 8 illustrates Marketable asset workflow for Central Bank. The Bank Treasury department will feed the Easy Collateral aggregated list of marketable assets typically daily. In the example, Easy Collateral interfaces with MEGARA. Megara is provided by Vermeg, which delivers real-time custodial risk software to central banks, financial institutions, CCPs and local and global custodians.

Step 1: Send eligibility request to Megara: A request is sent automatically to “MEGARA COPY” through APIs to run the eligibility check and receive the haircut value for the marketable asset.

Step 2: Check the Eligibility response from Megara: If the response received is “FALSE,” then: Asset Eligibility status will be set to “Not Eligible” in the inventory. The haircut value will be set to “N/A.” “Available value before haircut”=0. “Available value after a haircut”=0.

Then the system checks whether the asset is mobilized in ECMS or not: If “Yes,” a “Return Request” alert will be raised in the dashboard.

While the alert is processed, the user will be redirected to the demobilization screen, and the “mobilized” amount will be automatically filled. (Refer to Alert section) if “No, then the process will end.

If the response received is “TRUE,” the system will update the asset properties in the inventory screen of Easy Collateral with two attributes: The eligibility flag will be “Eligible.” The haircut will be populated with the value received from the Megara copy. A valuation request will then be sent to Megara Copy, and the process will proceed to the third step.

Step 3: Receive Valuation from Megara Copy: Valuation results are received from Megara, which leads to Easy Collateral updating both, the “Available value before haircut” & “Available value after a haircut” fields with proper values.

Step 4: Mobilization in Easy Collateral: To mobilize in Easy Collateral, the user must: Navigate to the “Mobilization” screen (Marketable Asset Tab).

Chooses the Marketable Assets & the Quantity of Nominal to Mobilize using the drag & drop process and the Slider. Click the “Confirm” button to validate. On the Mobilization screen, assets available must respect two conditions in inventory: is eligible=True. Available quantity>0.

The “Intended Settlement Date” default value will be set to T=current business date if the mobilization is processed before the cut-off time. The “Intended Settlement Date” value is editable only with upcoming business days.

If the mobilization is processed after the cut-off time, the “Intended Settlement Date” default value will be set to T+1. The “Intended Settlement Date” value is editable only with upcoming business days.

Once the mobilization is confirmed, the impact on the Marketable Asset in the inventory becomes apparent. (Refer to the below Excel file for the Mobilization impact on inventory)

By confirming the mobilization, a Marketable Asset Notification will be sent to Mega Broker with the below attributes: Attributes Type (Comment), Identifier (String) ISIN, Description (String) Label, Asset Category (Enum), Gov Corp Others, Portfolio/Account (String) Book (account), Place Of SafeKeeping (String), Quantity amount Quantity To Mobilize, Instruction Type (Enum) Value=“Mob,” Instruction Date (Date), Intended Settlement Date, Pool ECMS String Pool Collateral chez ECMS, Account ECMS (String) Internal Asset Account in ECMS, Mobilization Notification.

When Back-Office provides to Easy Collateral the confirmation status communicated by ECMS, then if: The mobilization is confirmed, and the Marketable Asset values in inventory will remain as they are.

If the mobilization is rejected, the system will change the Marketable Asset's values as stated before the Mobilization process.

Step 5: Demobilization in Easy Collateral: Assets available in the Demobilization screen must respect the condition: Total Mobilized Effective Value>0.

By confirming the Demobilization, a Marketable Asset Notification will be sent to Mega Broker with the below attributes: Attributes Type Comment, Identifier (String) ISIN, Description (String) Label, Asset Category (Enum), Gov Corp Others, Portfolio/Account (String) Book account, Place Of SafeKeeping (String), Quantity amount Quantity To Demobilize, Instruction Type (Enum) Value=“Demob,” Instruction Date (Date), Intended Settlement Date, Pool ECMS (String) Pool Collateral chez ECMS, Account ECMS (String) Internal Asset Account in ECMS, Demobilization Notification.

Mega Broker will communicate the Demobilization Instruction to the counterparty's Back Office, who will send it to ECMS & T2S.

The Back-Office will, in return, send back to Easy Collateral the confirmation response from ECMS: If the Demobilization is confirmed, the Marketable Asset values in inventory will remain the same.

If the Demobilization is rejected, the system will change the Marketable Asset's values as stated before the Demobilization process.

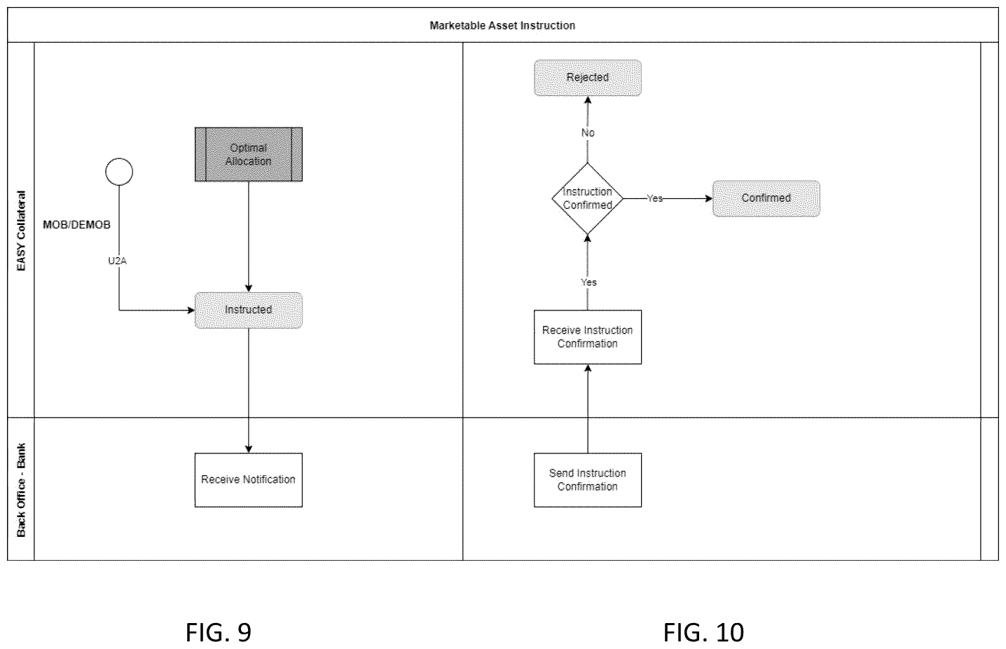

FIG. 9 illustrates Marketable Asset Instruction.

Step 1: Create (De) Mobilization Notification: When the user confirms the (De) Mobilization operation on Easy Collateral screens, the system creates a (De) Mobilization Notification based on the Transaction. Attributes detailed in the table below: Marketable Asset Transaction Type Comment, Transaction Reference (String) Unique Reference, Identifier (String) ISIN, Place of SafeKeeping (String), Transaction date Business Date, transaction-type (Enum), Mobilization, Demobilization, quantity Amount Quantity To (De) Mobilize, status (Enum), Instructed, Transaction attributes.

Step 2: Send Notification to Back-Office: Instruction status is set to “Instructed,” and the Notification is sent to the counterparty Back Office, which will communicate with ECMS and T2S.

Step 3: Receive Notification from Back-Office: The Back Office will, in return, communicate to Mega Broker the confirmation of the Instruction from ECMS.

Mega Broker sends the Notification to Easy Collateral to update the values in the inventory and the status of the Instruction: Status=Settled if the Instruction is Confirmed. Status=Rejected if the Instruction is Rejected and the Mob/Demob Calculation is rolled-back. Notification IN (provided by Cpty), Marketable Asset Transaction Type Comment, Transaction Reference (String) Unique Reference, Link To Reference (String) Reference of the Initial Message, Identifier (String) ISIN, Place of SafeKeeping (String), Transaction date Business Date, Transaction-type (Enum), Mobilization, Demobilization, Quantity Amount Quantity To (De)Mobilize, Status (Enum), Settled, Rejected, Rejection reason (String), Functional Reasons, Technical (Nack).

FIG. 10 illustrates marketable asset workflow for CCP.

Step 1: Mobilization in Easy Collateral: To mobilize assets for CCP, the user must: Navigate to the “Mobilization” screen (Marketable Asset Tab). Choose the Collateral account: Chooses the Marketable Assets & the Quantity of Nominal to Mobilize using the drag & drop process and the Slider (the assets list will be displayed from the inventory data). Click the “Confirm” button to validate.

On the Mobilization screen, if the user is using inventory, then assets available must respect one condition: available quantity>0. If the user isn't using inventory, then he's able to manually add assets in the Mobilization-Marketable asset tab. The “Intended Settlement Date” default value will be set to T=current business date if the mobilization is processed before the cut-off time. The “Intended Settlement Date” value is editable only with upcoming business days. If the mobilization is processed after the cut-off time, the “Intended Settlement Date” default value will be set to T+1. The “Intended Settlement Date” value is editable only with upcoming business days.

When the user confirms the mobilization: if the user using inventory=>available amount will get decreased by the mobilized quantity (Value will be calculated accordingly as per current behavior) if the user isn't using inventory=>nothing will happen.

Step 2: Deposit Approval. When a mobilization has been confirmed, a new transaction should be displayed in approval screen with Instruct type=Deposit. The user is able to approve or reject the transaction: The mobilization is approved, then it will not be displayed anymore in the approval screen, and it be displayed in the monitoring screen with “status=instructed.” The mobilization is rejected, then the Available amount for the Asset rollback to the initial state in the inventory. If the operation is approved, then the system generates a notification to be sent to the CCP via MegaBroker.

Step 3: Deposit Notification request. Attributes Type Comment, Identifier (String) ISIN, Description (String) Label, Asset Category (Enum), Gov Corp Others, Portfolio/Account (String) Book account, Place Of SafeKeeping (String), Quantity amount Quantity To Mobilize, Instruction Type (Enum) Value=“Mob,” Instruction Date (Date), Collateral Account (String) Internal Asset Account in CCP.

Step 4: Confirmation of the operation. Easy Collateral receives the response from CCP in the form of a notification received via XML notification to confirm the operation. Marketable Asset Transaction Type Comment, Transaction Reference (String) Unique Reference, Link To Reference (String) Reference of the Initial Message, Identifier (String) ISIN, Place of SafeKeeping (String), Transaction date Business Date, Transaction-type (Enum), Mobilization, Demobilization, Quantity Amount Quantity To (De) Mobilize, Status (Enum), Confirmed, Rejected, Rejection reason (String), Functional Reasons, Technical (Nack).

The system identifies the asset and the instruction via the identification attribute “Instruction reference” in the notification, then populates the field “Status” in the monitoring screen with its value in the notification provided by CCP. Values for the status can only be “Confirmed” or “Rejected”. Deposit operation confirmed: Inventory screen Cash asset values remain the same Monitoring screen Instruction status=confirmed. Send automatically a request to CCP to receive the new Collateral account image after the deposit operation Collateral account updated after receives the CCP update response Deposit operation is rejected: Inventory screen cash asset values go back to the initial situation before the deposit Monitoring screen Instruction status=rejected. End of process.

Step 5: Demobilization. To demobilize assets for CCP, the user must Navigate to the “Demobilization” screen. Choose the Collateral account. Chooses the Marketable Assets to Demobilize using the drag and drop process (the assets list will be displayed from the collateral account data). Click the “Confirm” button to validate. Assets available in the Demobilization screen must respect the one condition: Net Value After HC>0. By confirming the Demobilization: if the user using inventory=>available amount will be increased by the demobilized quantity (Value will be calculated accordingly as per current behavior) if the user not using inventory=>nothing happens

Example: Initial state inventory: Identifier Available Quantity, Mobilized Quantity Mobilized Value HC Currency, INSIN A 0 400.000 680.000 10% Euro, Withdrawal operation, Identifier Quantity, Mobilized Value HC Currency, INSIN A 400.000 680.000 10% Euro, Final state in inventory, Identifier Quantity, Available Value Mobilized, Quantity, HC Currency, INSIN A 400.000 680.000 0 10% Euro.

Step 6: Withdrawal Approval. When a demobilization has been confirmed, a new transaction should be displayed in approval screen with Instruct=withdrawal. The user is able to approve or reject the transaction: The demobilization is approved, then it will no longer be displayed in the approval screen, and it will be displayed in the monitoring screen, instead, with “status=instructed.” The mobilization is rejected, then the Available amount for the Asset rollback to the initial state (inventory) if the withdrawal is confirmed: A Marketable Asset Notification will be sent to Mega Broker (TBC).

Step 7: Withdrawal Notification Request. Attributes Type Comment, Identifier (String) ISIN, Description (String) Label, Asset Category (Enum), Gov Corp Others, Portfolio/Account (String) Book account, Place Of SafeKeeping (String), Quantity amount Quantity To Mobilize, Instruction Type (Enum) Value=“Mob,” Instruction Date (Date), Collateral Account (String) Internal Asset Account in CCP.

Step 8: Withdrawal confirmation. Easy Collateral receives the response from CCP in the form of a notification received via XML notification to confirm the operation. Marketable Asset Transaction Type Comment. Transaction Reference String Unique Reference. Link To Reference String Reference of the Initial Message, Identifier (String) ISIN, Place of SafeKeeping (String), Transaction date Business Date, Transaction-type (Enum), Mobilization, Demobilization, Quantity Amount Quantity To (De) Mobilize, Status (Enum), Confirmed, Rejected, Rejection reason (String), Functional Reasons, Technical (Nack).

The system identifies the asset and the instruction via the identification attributes in the notification, then populates the field “status” with its value in the notification provided by CCP. Withdrawal operation confirmed: Inventory screen MA asset values remain the same Monitoring screen Instruction status=confirmed. Send automatically a request to CCP to receive the new Collateral account image after the withdrawal operation. Collateral account updated after receiving the CCP update response. Withdrawal operation is rejected: Inventory screen MA asset values go back to the initial situation before the Withdrawal. Monitoring screen Instruction status=rejected. End of process.

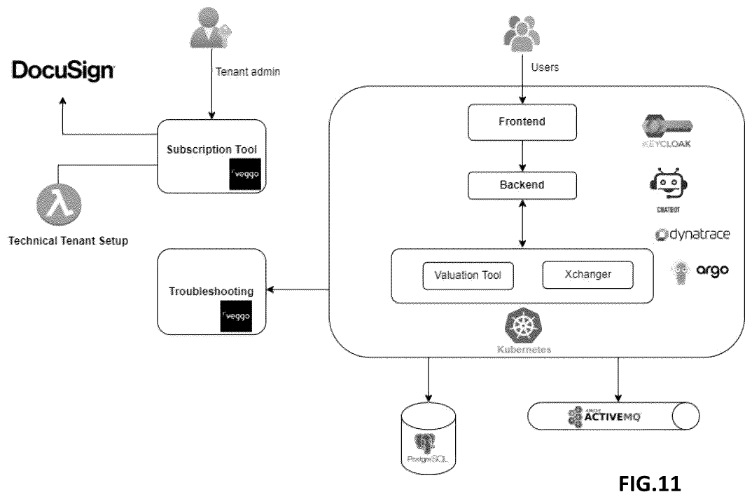

FIG. 11 is an overview of cloud implementation of Easy Collateral systems. The users interact with the Easy Collateral Frontend, which communicates with the Backend. The Backend interfaces and utilizes the services provided by the Valuation Tool and Xchanger. EasyCollateral is a cloud native application can be deployed with Kubernetes, an open-source container orchestration platform. ArgoCD can be used for continuous delivery of applications to Kubernetes clusters. Secure authentication, authorization, and user management can be provided by Keycloak. Dynatrace can be used for monitoring and managing the performance of applications and infrastructure in cloud-based environments. Chabot can also be utilized to facilitate with user interaction. Database functionality can be implemented with PostgreSQL, a powerful open-source, object-relational database management system (ORDBMS). Exchange of messages and communication between various components of is facilitated by ActiveMQ.

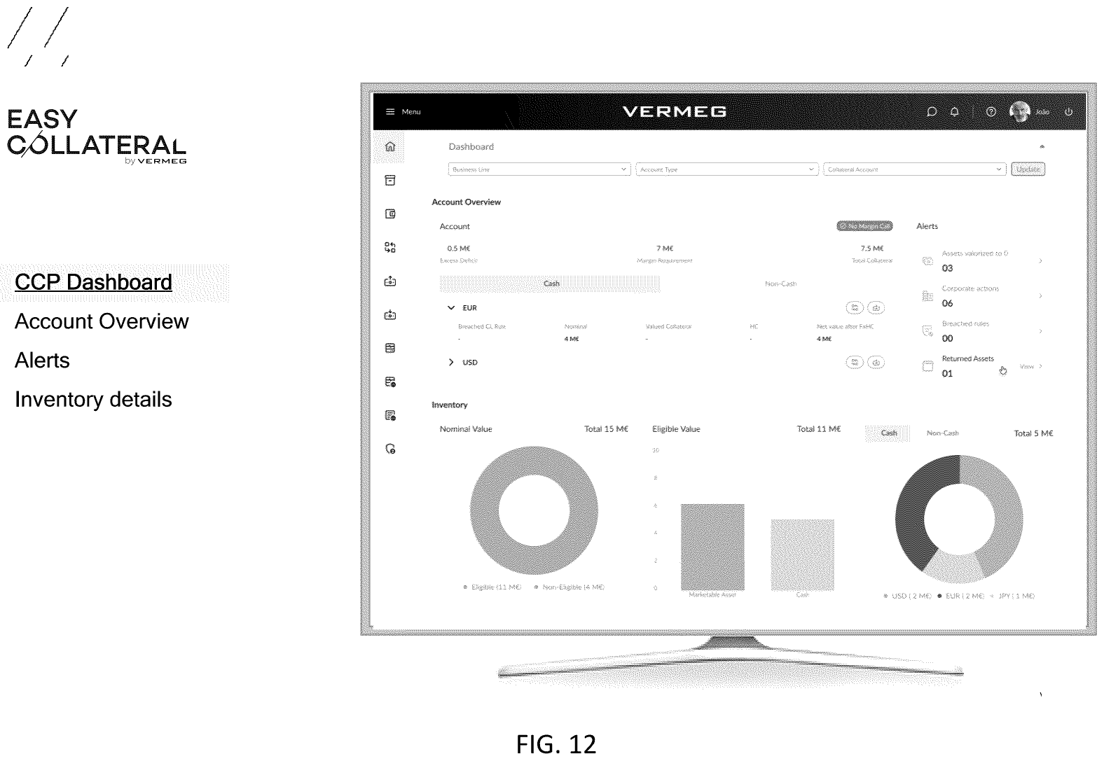

FIG. 12 is an example of Easy Collateral CCP Dashboard. The dashboard provides Account Overview, Inventory, and Alters.

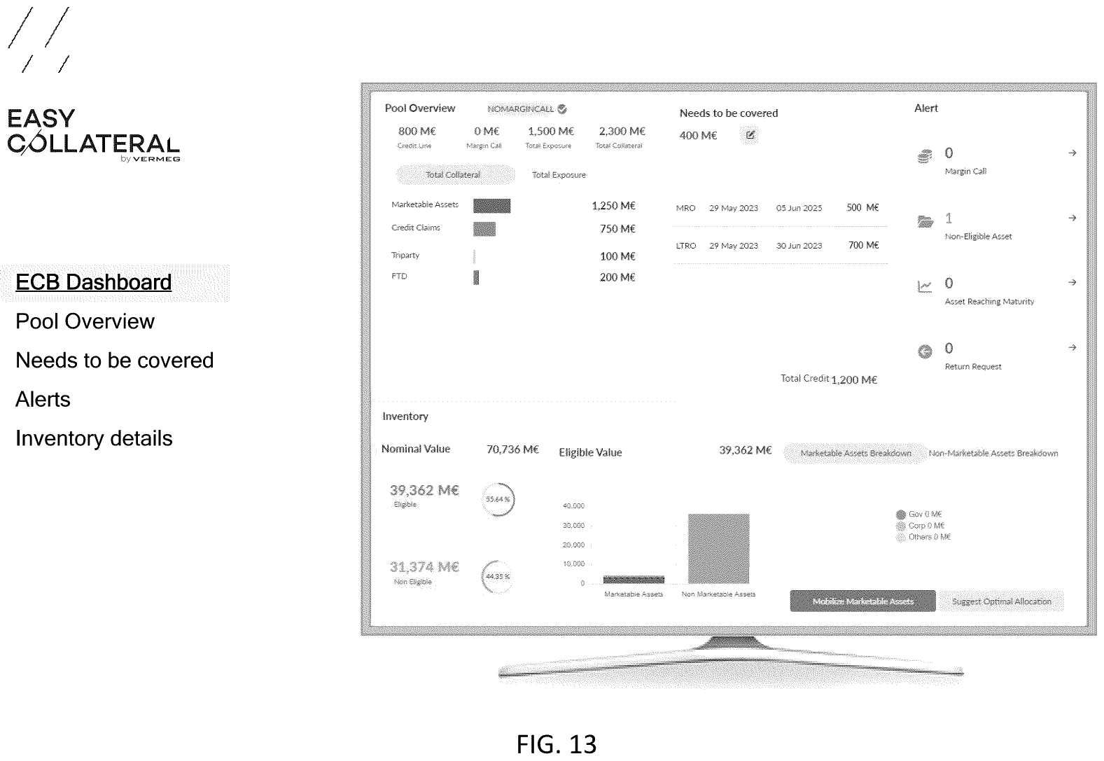

FIG. 13 is example of Easy Collateral ECB Dashboard. The dashboard provides Pool Overview, Needs to be covered, Inventory details, and alters.

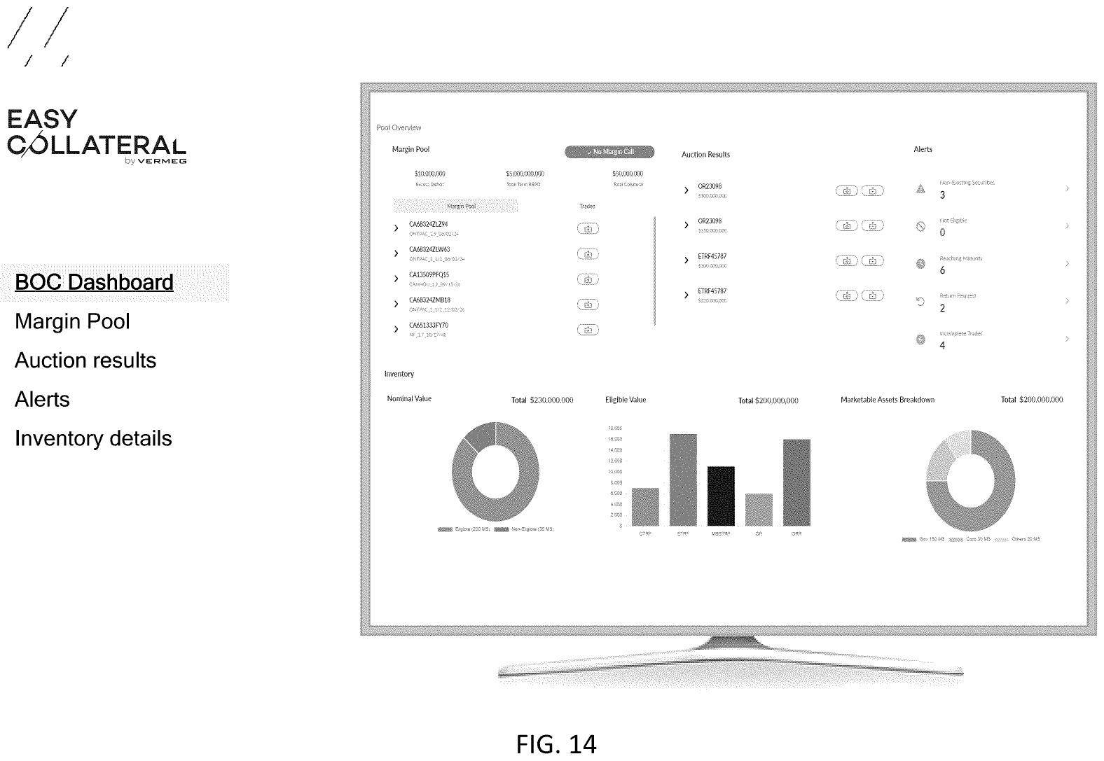

FIG. 14 is example of Easy Collateral Central Bank Dashboard. The dashboard provides Margin Pool, Auction results, Inventory details, and alters.

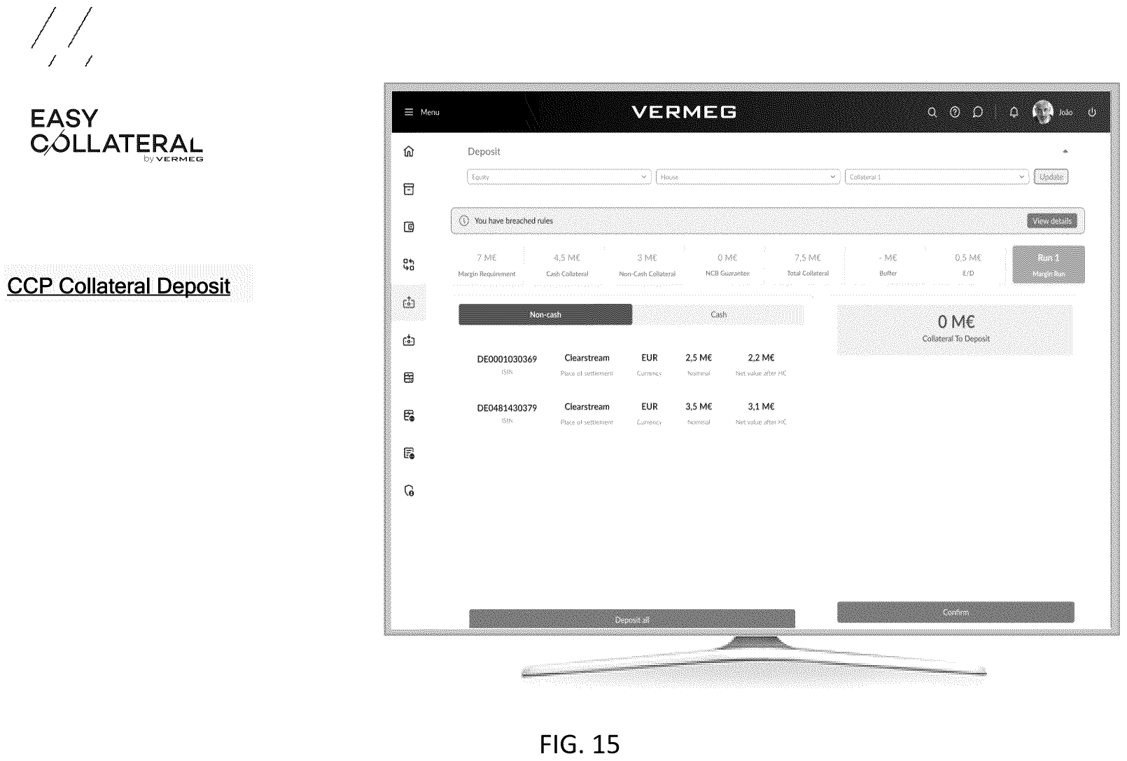

FIG. 15 is example of Easy Collateral screen for CCP collateral deposit.

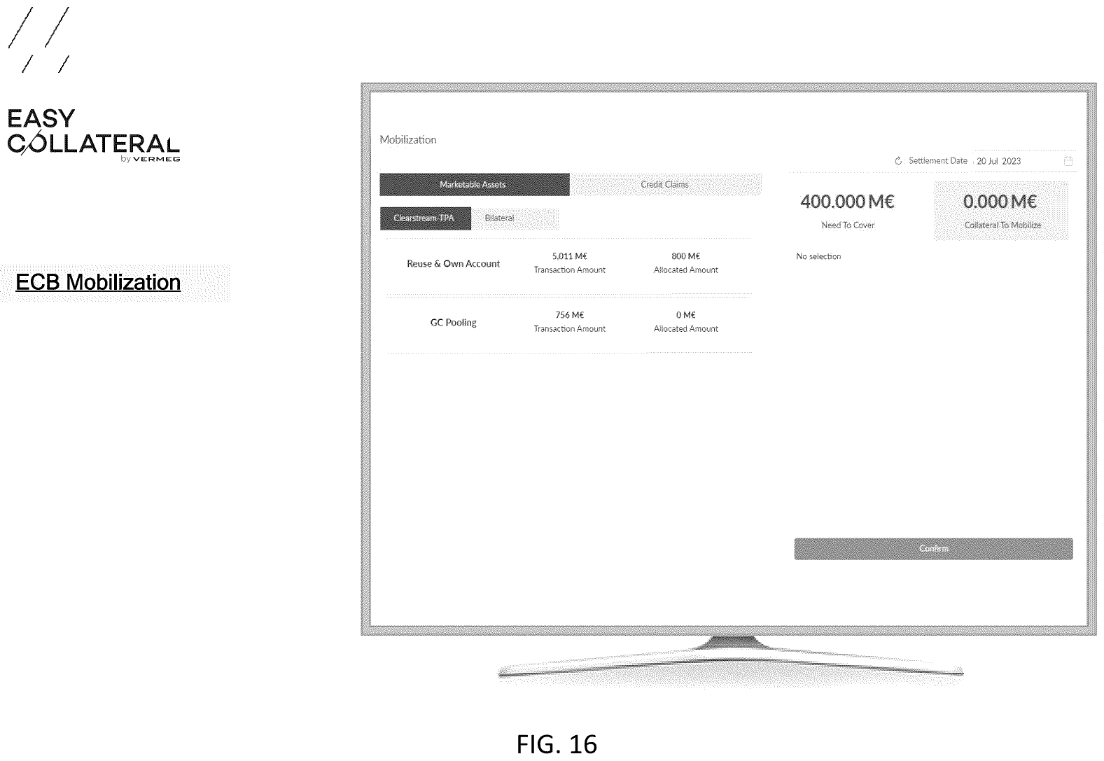

FIG. 16 is example of Easy Collateral screen for ECB mobilization.

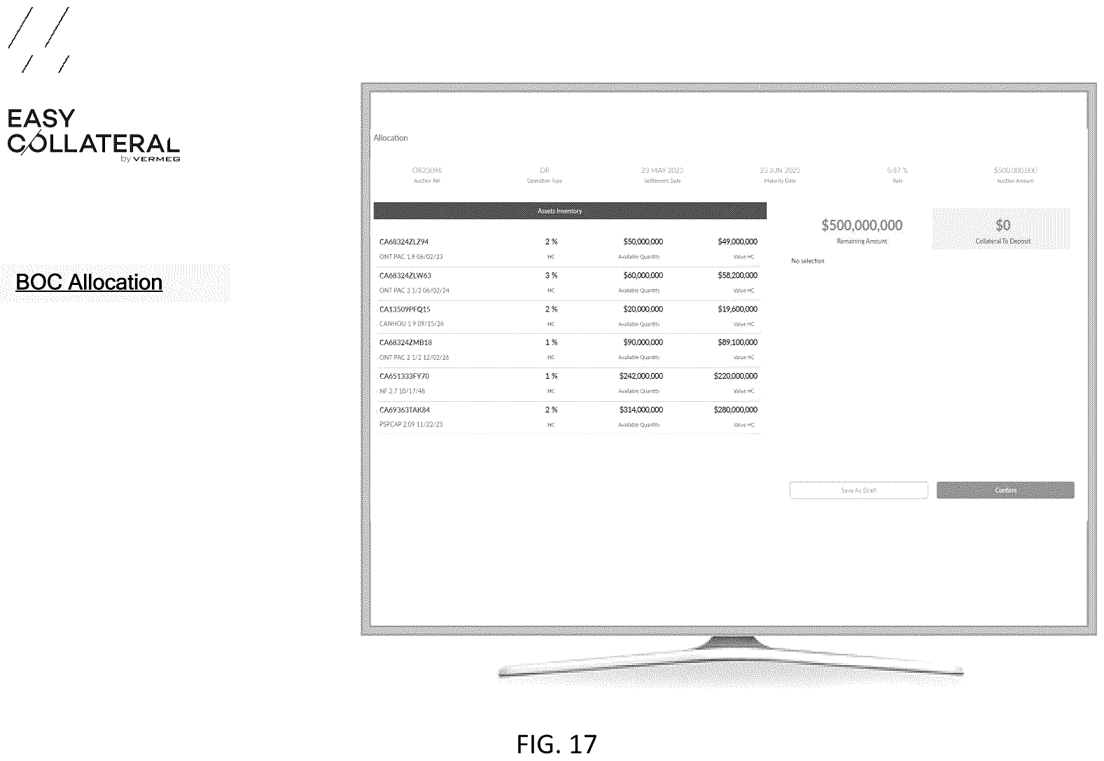

FIG. 17 is example of Easy Collateral screen for central bank allocation.

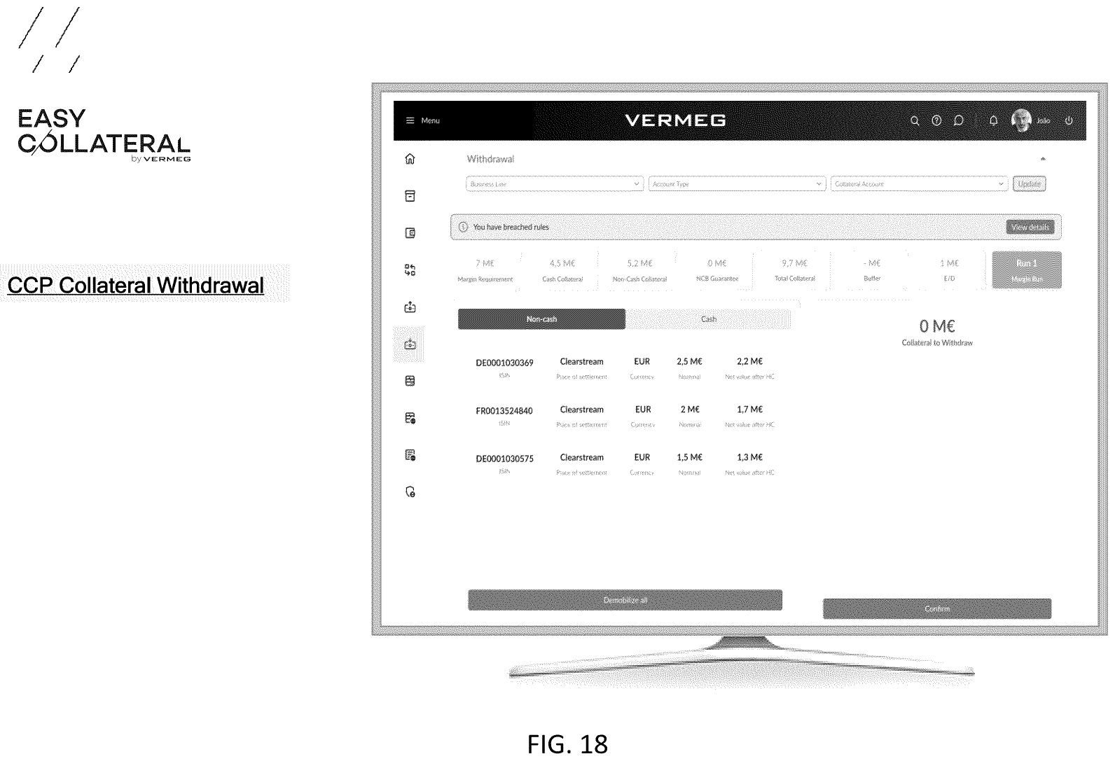

FIG. 18 is example of Easy Collateral screen for CCP collateral withdrawal.

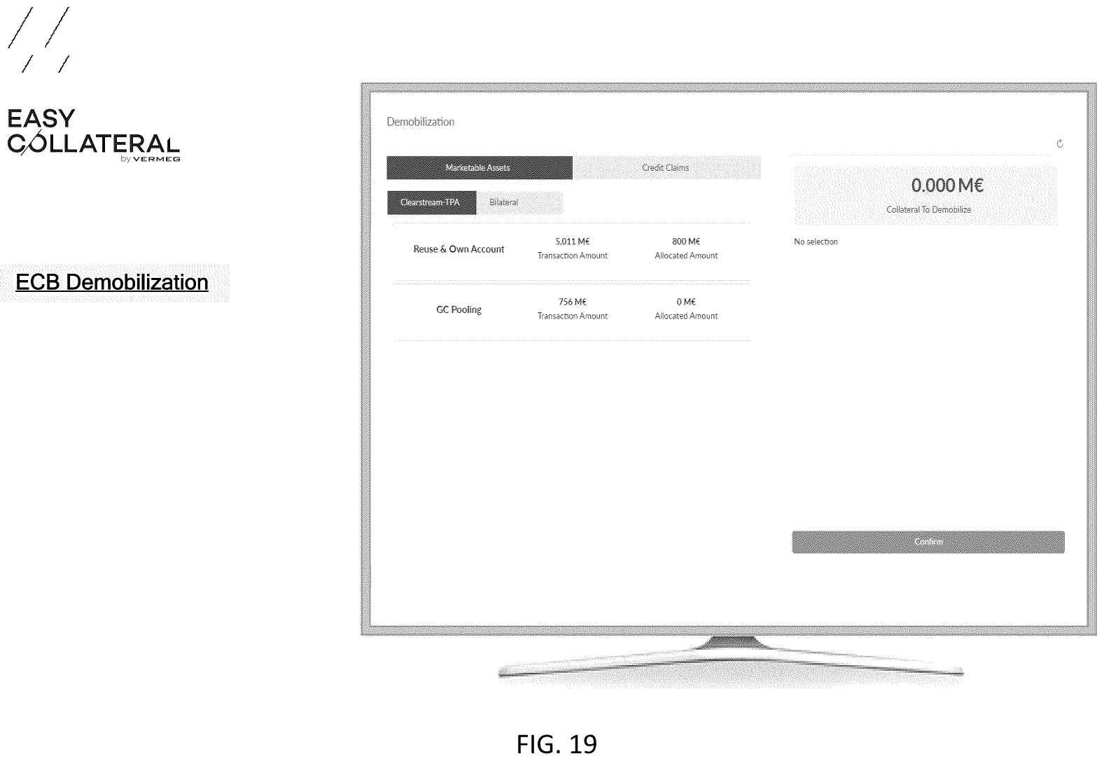

FIG. 19 is example of Easy Collateral screen for ECB demobilization.

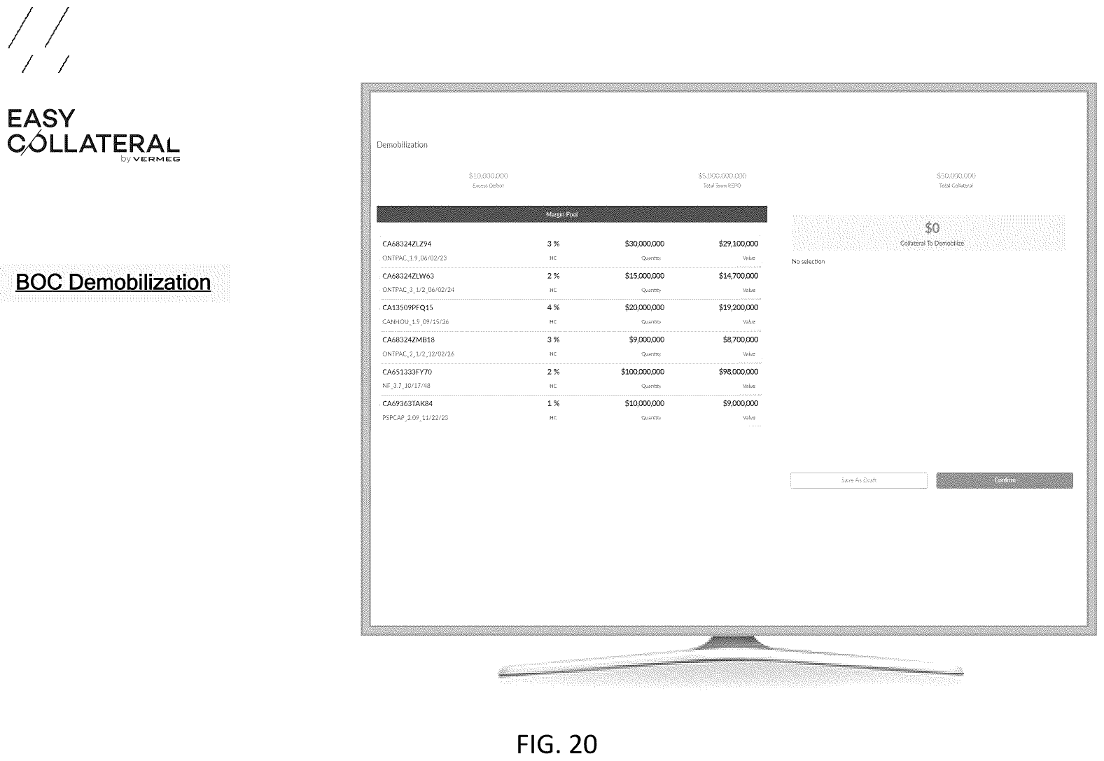

FIG. 20 is example of Easy Collateral screen for central bank demobilization.

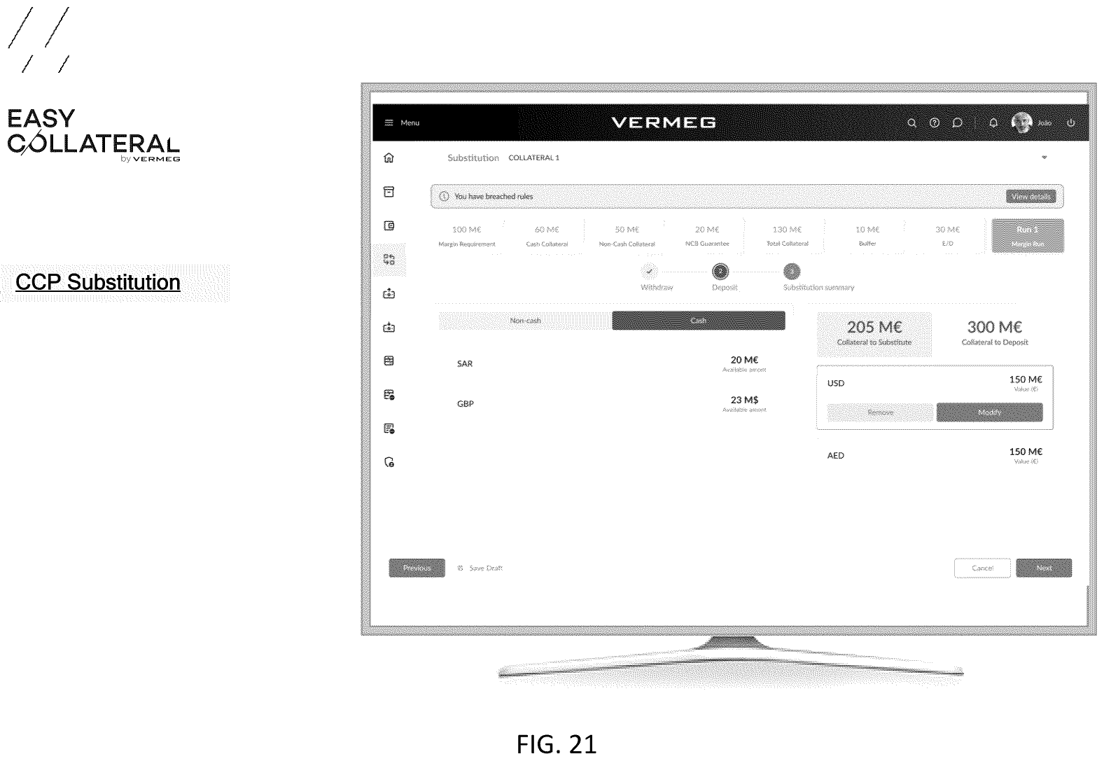

FIG. 21 is example of Easy Collateral screen for CCP collateral substitution.

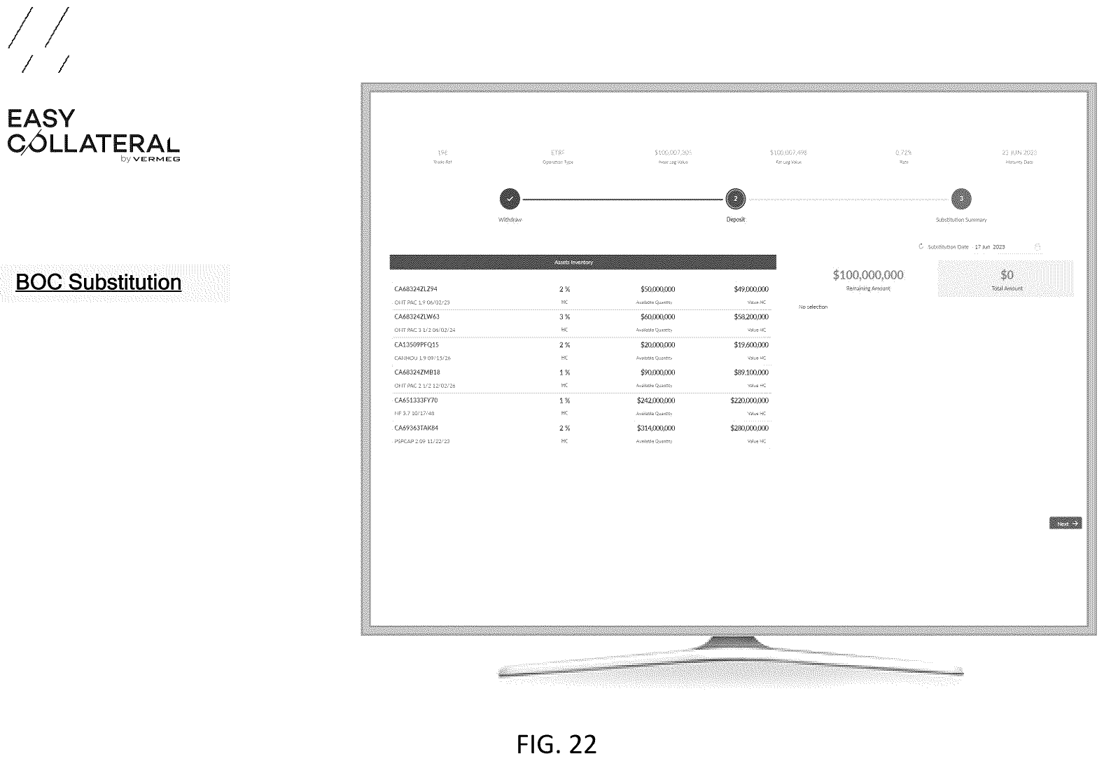

FIG. 22 is example of Easy Collateral screen for central bank collateral substitution.

All documents mentioned in this specification are incorporated herein by reference in their entirety for all purposes.

It is to be understood the implementations are not limited to particular systems or processes described which may, of course, vary. It is also to be understood that the terminology used herein is for the purpose of describing particular implementations only and is not intended to be limiting. As used in this specification, the singular forms “a”, “an” and “the” include plural referents unless the content clearly indicates otherwise.

Although the present disclosure has been described in detail, it should be understood that various changes, substitutions and alterations may be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

We claim:

1. A computer-implemented system for collateral management, comprising:
a digital dashboard configured to provide real-time access to a user's inventory of collateral assets, said assets comprising at least one of cash, marketable assets, or credit claims;
a collateral allocation module enabling the allocation, mobilization, and demobilization of said collateral assets;
an eligibility module configured to verify the eligibility of said collateral assets based on predefined criteria;
a valuation module configured to determine real-time market values of said collateral assets;
an asset allocation optimizer configured to recommend optimized allocation of collateral assets for financial transactions based on risk profiles and user-defined preferences;
a messaging module configured to communicate with an external collateral management and transaction system; and
a monitor module configured to track changes related to said collateral assets.

2. The system of claim 1, wherein the external collateral management and transaction system is selected from the group consisting of the Eurosystem Collateral Management System, Clearstream, or a central bank collateral management system.

3. The system of claim 1, wherein the messaging module is configured to communicate with the external collateral management and transaction system via at least one of SWIFT messages or Central Counterparty Clearing House notifications.

4. The system of claim 1, further comprising an alert system configured to notify users of critical events including margin calls, coupon payments, or changes in asset status in real time.

5. The system of claim 1, wherein the collateral allocation module is further configured to automatically adjust collateral allocations in response to changes in asset valuation or margin call requirements.

6. The system of claim 1, wherein the digital dashboard is further configured to provide graphical representations of collateral positions, asset valuations, and transaction histories for improved user experience.

7. The system of claim 1, further comprising an audit module configured to generate comprehensive audit logs for all transactions and changes related to collateral assets.

8. The system of claim 1, wherein the eligibility module is further configured to update eligibility criteria dynamically based on changes in regulatory requirements or market conditions.

9. The system of claim 1, wherein the asset allocation optimizer is further configured to simulate various allocation scenarios based on different risk profiles, market conditions, and user preferences.

10. The system of claim 1, further comprising a compliance module configured to ensure that all collateral allocations adhere to predefined regulatory standards.

11. The system of claim 1, wherein the collateral assets include non-marketable assets such as credit claims and real estate, and the system is configured to manage the mobilization and demobilization of these non-marketable assets.

12. The system of claim 1, wherein the valuation module is further configured to integrate with external market data feeds for real-time updates on asset values, interest rates, and currency exchange rates.

13. The system of claim 1, wherein the messaging module is further configured to receive notifications from external collateral management systems regarding transaction confirmations, rejections, or settlement updates.

14. A method for managing collateral assets using a computer-implemented system, the method comprising:
providing a user with real-time access to a digital dashboard displaying collateral assets inventory;
verifying the eligibility of said collateral assets using an eligibility module based on predefined criteria;
determining real-time market values of said collateral assets through a valuation module;
optimizing the allocation of said collateral assets for financial transactions using an asset allocation optimizer;
communicating with an external collateral management and transaction system via a messaging module; and
monitoring and tracking changes related to said collateral assets using a monitor module.

15. The method of claim 14, wherein the external collateral management and transaction system is integrated with the Eurosystem Collateral Management System or Clearstream.

16. The method of claim 14, further comprising receiving and processing margin call alerts and updating the allocation of collateral assets accordingly.

17. The method of claim 14, further comprising automatically rebalancing collateral allocations in response to market fluctuations or changes in collateral eligibility.

18. The method of claim 14, further comprising simulating various collateral allocation strategies and providing recommendations based on projected risk and liquidity needs.

19. The method of claim 14, further comprising generating audit logs for all collateral-related transactions, including allocations, mobilizations, and demobilizations.

20. The method of claim 14, further comprising validating collateral assets using both internal eligibility criteria and external regulatory requirements before mobilization in financial transactions.
